(19) United States
(12) Patent Application Publication
(10) Pub. No.: US 2007/0038359 A1
(43) Pub. Date: Feb. 15, 2007

(54) Method of controlling a homogenous-charge compression-ignition engine

(75) Inventors: Jean-Marc Duclos, Forges-les-Bains (FR); Jacky Guezet, Les Cresnays (FR); Cedric Servant, Puteaux (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: RENAULT s a.s, Boulogne-Billancourt (FR)

(21) Appl. No.: 10/548,441

(22) PCT Filed: Mar. 12, 2004
(86) PCT No.: PCT/FR04/00615

§ 371 Date: Aug. 24, 2006

(30) Foreign Application Priority Data
Mar. 12, 2003 (FR) 03/03037

(51) Int. Cl. G06G 7/70

(52) U.S. Cl. 701/101

(57) ABSTRACT

The invention relates to a method of controlling a homogenous-charge compression-ignition engine. According to the invention, a homogenous-charge compression-ignition piston engine comprises an ionisation detector (5) supplying an ionisation signal I(t) which is associated with the combustion in a cylinder (12), and at least one actuator (7, 21, 10, 10′) which acts on one operating parameter of the motor. The inventive engine control method consists in: processing the ionisation signal (I(t)) in order to determine a maximum pressure instant (αPmax); comparing the maximum pressure instant (αPmax) with a set value for the maximum pressure instant (αPmaxC); and acting on at least one operating parameter of the engine such that the maximum pressure instant (αPmax) corresponds to the set value (αPmaxC).

The invention relates to a method for control of an internal-combustion piston engine having ignition by compression of a homogeneous mixture, and more particularly for regulation of the combustion.

In this type of engine, a mixture of air and fuel is introduced into a cylinder well before a piston sliding in the cylinder reaches top dead center. Ignition of the mixture is achieved by compression of the mixture and by the resulting temperature rise. These engines are characterized by low emission of particles and nitrogen oxides. They are known under the English abbreviation of HCCI (Homogeneous Charge Compression Ignition).

However, a problem arises as regards control over the period of combustion of the mixture, or in other words both the start of combustion and the rate of combustion. International Patent WO 02/48522 proposes a method for regulating an HCCI engine in which a pressure sensor in the cylinder delivers a measured pressure signal and a calculator differentiates this measurement in order to detect a first step of combustion. The calculator then commands an injection of water into the cylinder in order to retard the start of a second step of combustion. In this way, the second step of combustion takes place in a chosen period, which makes it possible to achieve optimal combustion efficiency.

The pressure sensors inside the cylinder of an engine are bulky. One objective of the invention is therefore to propose a different method of control of an HCCI engine in order to regulate the combustion, by using a different type of sensor.

With this objective in mind, the object of the invention is a method for control of a piston engine operating with ignition by compression of a homogeneous mixture, the engine being provided with a sensor yielding combustion information in connection with the combustion in the cylinder, in which method the combustion information is processed to determine a combustion instant, the combustion instant is compared with an index value of the combustion instant and an operating parameter of the engine is acted on so that the combustion instant and the index value correspond. According to the invention, the sensor is an ionization detector placed in the cylinder and delivering an ionization current as combustion information, the combustion instant corresponding to the instant of maximum pressure in the cylinder.

In fact, the inventor has observed that the signal of an ionization detector placed in the cylinder varies during combustion in the cylinder, and that it is possible to deduce therefrom information on the manner in which combustion is proceeding. By processing this information, it is possible to deduce therefrom the instant at which the pressure is maximum in the cylinder. An index value is established for the instant of maximum pressure and, by acting on at least one operating parameter, the engine is activated so that the measurement follows the index value.

Preferably the operating parameters include an exhaust-gas recirculation ratio. The inventor has noted that, by adjusting this recirculation ratio, it is possible to act effectively on the start and course of combustion in the cylinder and thus on the instant at which the maximum pressure is reached in the cylinder.

The operating parameters also include turbulence created by an intake-air turbulence generator and a variation of the intake or exhaust cycle. All of these parameters have an influence on the progress of combustion in the cylinder.

According to a first embodiment, a recirculation signal is determined in order to command an actuator that determines the recirculation ratio, a signal index value being predetermined as a function of the operating point of the engine, a signal for correction of the recirculation signal is determined as a function of the comparison between the combustion instant and the index value of the combustion instant, and the correction signal is added to the index value of the recirculation signal in order to determine the recirculation signal. In this way, an index value for the operating parameter of the engine is first determined as a function of the operating point of the engine, then this parameter is acted on by adjusting it by a regulation procedure that introduces a correction of its index value.

It is advantageous to act on a plurality of operating parameters simultaneously. In this way, in addition to the progress of combustion in time, it is possible to act on the maximum pressure and on the temperature reached in the cylinder, which influences the efficiency of combustion, the noise emitted and the production of polluting products.

According to a second embodiment, index values are determined for activation signals used to command actuators that determine the operating parameters, the index values of the activation signals being predetermined as a function of the operating point of the engine, signals for correction of the index values for the activation signals are determined as a function of the comparison between the combustion instant and the index value of the combustion instant, and the correction signals are added to the index values to determine the respective activation signals.

Another object of the invention is a piston engine operating with ignition by compression of a homogeneous mixture, provided with:
a sensor yielding combustion information in connection with the combustion in the cylinder,
at least one actuator acting on an operating parameter of the engine,
a calculator receiving and processing the combustion information in order to determine a combustion instant, determining an index value of the combustion instant, comparing the combustion instant with the index value of the combustion instant, and activating the actuator to act on the operating parameter of the engine so that the combustion instant and the index value correspond,
   characterized in that the sensor is an ionization detector placed in the cylinder and delivering an ionization current as combustion information, the combustion instant corresponding to the instant of maximum pressure in the cylinder.

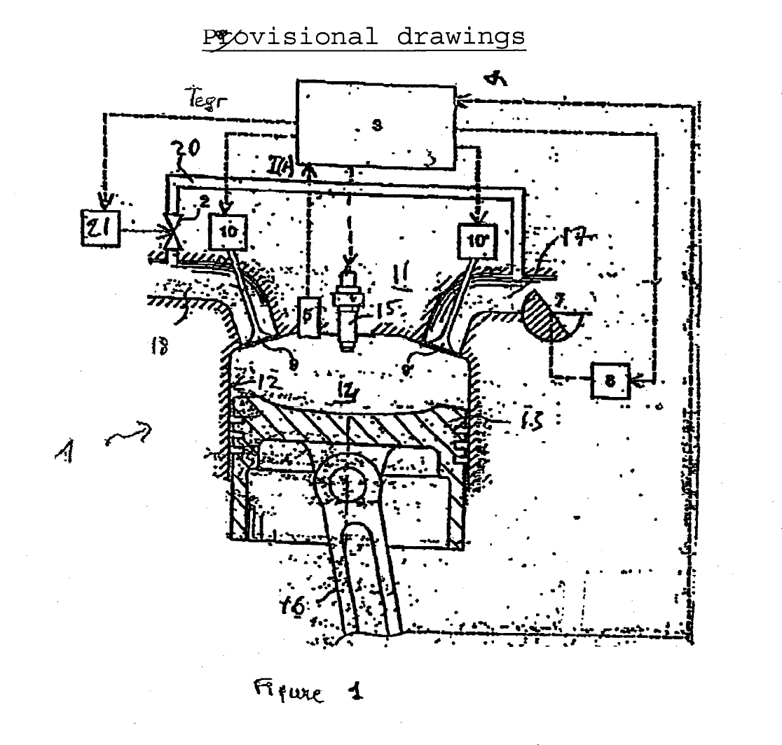

The invention will be better understood and other particulars and advantages will become apparent upon reading the description hereinafter, the description referring to FIG. 1, which is a view in axial section of a cylinder of an engine according to the invention.

In FIG. 1, reference 1 denotes an HCCI internal combustion engine, having ignition by compression of a homogeneous mixture composed of air and fuel, such as diesel oil. Only part of cylinder head 11 and a cylinder 12 are illustrated. A piston 13 slides in cylinder 12 and defines with the latter and the cylinder head a combustion chamber 14. Combustion chamber 14 is also provided with a fuel injector 15 and an ionization detector 5. The piston causes a crankshaft (not illustrated) to rotate, via the intermediary of a piston rod, in a manner known in itself. A sensor (not illustrated) yields information on the angle α of the instantaneous position of the crankshaft as a function of time.

Cylinder head 11 is provided with an intake conduit 17 running into combustion chamber 14 and having a mouth size controlled by an intake valve 9′. Cylinder head 11 is also provided with an exhaust conduit 18 running into combustion chamber 14 and having a mouth size controlled by an exhaust valve 9. A distribution system is provided with an intake actuator 10′ and an exhaust actuator 10, which actuate intake valve 9′ and exhaust valve 9 respectively. Intake conduit 17 is equipped with a turbulence generator 7 actuated by an actuator 8.

Engine 1 is also provided with an exhaust-gas recirculation circuit 20. Recirculation circuit 20 is provided with a recirculation valve 2 activated by a recirculation actuator 21 in order to open or close recirculation circuit 20. In this way, the recirculation circuit can transport exhaust gases from exhaust conduit 18 to intake conduit 17.

Engine 1 is activated by an engine calculator 3, such as a microprocessor. The engine calculator receives information streams originating from the engine, and it activates the actuators that control the engine. Among the information streams that card 3 receives are an ionization signal I(t) as a function of time, originating from the ionization detector, and the crankshaft position α. Engine calculator 3 activates the actuators of valves 10, 10′, actuator 8 of the turbulence generator, injector 15 and recirculation actuator 21.

Engine 1 comprises a four-stroke cycle, or in other words, in a manner known in itself, successive phases of intake, compression, expansion and then exhaust. For engine 1, air is admitted during the intake phase, and fuel is injected into the combustion chamber during the compression phase, or in other words when the piston passes from bottom dead center to top dead center, reducing the volume of the combustion chamber. To obtain a homogeneous mixture, the fuel is injected while the piston is still close to the bottom dead center position. As a result, the fuel becomes vaporized during a large portion of the compression phase, and in this way forms a substantially homogeneous mixture at the end of the compression phase.

During compression, the mixture of air and fuel contained in the combustion chamber heats up because of the compression that it is undergoing, until it reaches a spontaneous ignition temperature, at least locally, when the piston is close to top dead center. The combustion then propagates progressively to the entire mixture, and the pressure in the combustion chamber rises to a maximum. Once the piston has passed the position of top dead center, the volume of the combustion chamber increases and the expansion phase begins. The maximum pressure is generally attained during this period. Expansion continues while the burned gases are expanding, performing work on the piston. Thereafter the exhaust phase takes place and a new cycle begins once again.

The signal I(t) delivered by the ionization detector is processed by the engine calculator in order to determine an instant of maximum pressure αPmax expressed in the form of a crankshaft position. The Applicant for the present patent application has already developed a method for determination of this instant of maximum pressure from an ionization signal I(t) issued by an ionization detector. This method is disclosed in French Patent 2813920 and is not reproduced here. It can be applied here in the same manner.

The engine, calculator contains, in a memory, tables of index values for activation signals for the engine actuators, such as the distribution system 10, 10′, the turbulence generator, the injector or the recirculation actuator. The index values for the activation signals are determined as a function of the operating point of the engine. They correspond to compromises between consumption, emission of polluting products such as nitrogen oxides, unburned hydrocarbons, soot and noise emission. The tables of index values for activation signals are determined during tuning of the engine.

The engine calculator also contains, in a memory, a table of index value values αPmaxC for the instant of maximum pressure. The index value αPmaxC is determined as a function of the operating point of the engine, on the basis of information streams received by the calculator. It is expressed in the form of an angle representing the crankshaft position, which is equivalent to an instant when the crankshaft position is related to its speed of revolution. The index value αPmaxC and the instant αPmax of maximum pressure are entered into a comparison algorithm, which generates signals for correction of the activation of the actuators of the engine. The correction signals are added to the activation signals, and thus make it possible to regulate the instant of maximum pressure in a closed loop.

In a first embodiment, the comparison algorithm permits only the recirculation of the exhaust gases to be acted on, by delivering a recirculation signal Tegr. This is the case, for example, when the engine lacks variable distribution and a turbulence generator. A correction CorrTegr of the activation of the position of the recirculation valve is added to an index value TegrC for activation of recirculation in order to determine the activation signal Tegr. The correction CorrTegr is, for example, proportional to the difference between the index value αPmaxC and the instant αPmax of maximum pressure. In this way, the index value for activation of the valve is corrected so that the instant of maximum pressure corresponds to an optimum defined by the index value αPmaxC.

In another embodiment, the comparison algorithm generates a plurality of correction signals destined for different actuators. In this way, a plurality of parameters acts simultaneously in order to correct the instant of maximum pressure. The distribution of the correction is also stored in memory in a table and is determined as a function of the operating point. The table is established during tuning of the engine, with the goal of not perturbing the compromises established for each operating point.

The invention is not limited to the embodiments described solely by way of example. The engine can include, for example, a turbocompressor or a plurality of injectors, to which the method according to the invention can be applied. The fuel can be of any nature whatsoever, such as natural gas or gasoline. The correction signal can be determined by different regulation algorithms.

1-7. (canceled)

8. A method for control of a piston engine operating with ignition by compression of a homogeneous mixture, the engine including a sensor yielding combustion information in connection with the combustion in a cylinder, the method comprising:
processing the combustion information to determine a combustion instant;
comparing the combustion instant with an index value of the combustion instant; and
acting on at least one operating parameter of the engine so that the combustion instant and the index value correspond,
wherein the sensor is an ionization detector placed in the cylinder and delivers an ionization current as the combustion information, the combustion instant corresponding to the combustion instant of maximum pressure in the cylinder.

9. A control method according to claim 8, wherein the operating parameters include an exhaust-gas recirculation ratio.

10. A control method according to claim 9, wherein a recirculation signal is determined to command an actuator that determines the recirculation ratio, a signal index value being predetermined as a function of an operating point of the engine, a signal for correction of the recirculation signal is determined as a function of the comparison between the combustion instant and the index value of the combustion instant, and the correction signal is added to the index value of the recirculation signal to determine the recirculation signal.

11. A control method according to claim 9, wherein the operating parameters also include turbulence created by an intake-air turbulence generator and a variation of an intake or exhaust cycle.

12. A control method according to claim 8, wherein a plurality of operating parameters are acted on simultaneously.

13. A control method according to claim 12, wherein index values are determined for activation signals used to command actuators that determine the operating parameters, the index values of the activation signals being predetermined as a function of an operating point of the engine, signals for correction of the index values for the activation signals are determined as a function of the comparison between the combustion instant and the index value of the combustion instant, and the correction signals are added to the index values to determine the respective activation signals.

14. A piston engine operating with ignition by compression of a homogeneous mixture and comprising:
a sensor yielding combustion information in connection with the combustion in a cylinder;
at least one actuator acting on an operating parameter of the engine;
a calculator receiving and processing the combustion information to determine a combustion instant, determining an index value of the combustion instant, comparing the combustion instant with the index value of the combustion instant, and activating the at least one actuator to act on the operating parameter of the engine so that the combustion instant and the index value correspond,
wherein the sensor is an ionization detector placed in the cylinder and delivering an ionization current as the combustion information, the combustion instant corresponding to the combustion instant of maximum pressure in the cylinder.
